(19) United States
(12) Patent Application Publication
(10) Pub. No.: US 2012/0279603 A1
(43) Pub. Date: Nov. 8, 2012

(54) BLOW OUT PREVENTER METHOD AND APPARATUS

(76) Inventor: Jason Swist, Edmonton (CA)

(21) Appl. No.: 13/461,028

(22) Filed: May 1, 2012

Related U.S. Application Data
(60) Provisional application No. 61/481,798, filed on May 3, 2011.

(51) Int. Cl. F16L 9/00; B23P 11/00

(52) U.S. Cl. 138/109; 29/428

(57) ABSTRACT

Existing BOP devices are complex electromechanical systems exploiting hydraulic activation of pipe rams and/or shear rams. With tens of thousands of oil wells in the 1,500 oil fields that account for 97% of global production of the over 40,000 oil fields identified to date and failure rates as high as 50% in disaster situations it is evident that a simpler, increased reliability approach would be beneficial to the oil and gas industries. It would be further beneficial if the BOP was automatic requiring no monitoring locally to the BOP or remotely from the rig or production facility.

### CROSS-REFERENCE TO RELATED APPLICATIONS

This patent application claims the benefit of U.S. Provisional Patent Application 61/481,798 filed May 3, 2011 entitled “Blow Out Preventer Method and Apparatus.”

### FIELD OF THE INVENTION

This invention relates to blowout preventers and more specifically to low complexity automatic blowout preventers.

### BACKGROUND OF THE INVENTION

Over the last two centuries, advances in technology have made our civilization completely oil, gas & coal dependent. Whilst gas and coal are primarily use for fuel oil is different in that immense varieties of products are and can be derived from it. A “brief” list of some of these products includes gasoline, diesel, fuel oil, propane, ethane, kerosene, liquid petroleum gas, lubricants, asphalt, bitumen, cosmetics, petroleum jelly, perfume, dish-washing liquids, ink, bubble gums, car tires, etc. In addition to these oil is the source of the starting materials for most plastics that form the basis of a massive number of consumer and industrial products.

Table 1 below lists the top 15 consuming nations based upon 2008 data in terms of thousands of barrels (bbl) and thousand of cubic meters per day. FIG. 1A presents the geographical distribution of consumption globally.

TABLE 1
2008 Oil Consumption for Top 15 Consuming Nations

| | Nation | (1000 bbl/day) | (1000 m³/day) [symbol] |
|---|---|---|---|
| 1 | United States | 19,497.95 | 3,099.9 |
| 2 | China | 7,831.00 | 1,245.0 |
| 3 | Japan | 4,784.85 | 760.7 |
| 4 | India | 2,962.00 | 470.9 |
| 5 | Russia | 2,916.00 | 463.6 |
| 6 | Germany | 2,569.28 | 408.5 |
| 7 | Brazil | 2,485.00 | 395.1 |
| 8 | Saudi Arabia | 2,376.00 | 377.8 |
| 9 | Canada | 2,261.36 | 359.5 |
| 10 | South Korea | 2,174.91 | 345.8 |
| 11 | Mexico | 2,128.46 | 338.4 |
| 12 | France | 1,986.26 | 315.8 |
| 13 | Iran (OPEC) | 1,741.00 | 276.8 |
| 14 | United Kingdom | 1,709.66 | 271.8 |
| 15 | Italy | 1,639.01 | 260.6 |

In terms of oil production Table 1B below lists the top 15 oil producing nations and the geographical distribution worldwide is shown in FIG. 1B. Comparing Table 1A and Table 1B shows how some countries like Japan are essentially completely dependent on oil imports whilst most other countries such as the United States in the list whilst producing significantly are still massive importers. Very few countries, such as Saudi Arabia and Iran are net exporters of oil globally.

TABLE 2
Top 15 Oil Producing Nations

| | Nation | (1000 bbl/day) | Market Share |
|---|---|---|---|
| 1 | Saudi Arabia | 9,760 | 11.8% |
| 2 | Russia | 9,934 | 12.0% |
| 3 | United States | 9,141 | 11.1% |
| 4 | Iran (OPEC) | 4,177 | 5.1% |
| 5 | China | 3,996 | 4.8% |
| 6 | Canada | 3,294 | 4.0% |
| 7 | Mexico | 3,001 | 3.6% |
| 8 | UAE (OPEC) | 2,795 | 3.4% |
| 9 | Kuwait (OPEC) | 2,496 | 3.0% |
| 10 | Venezuela (OPEC) | 2,471 | 3.0% |
| 11 | Norway | 2,350 | 2.8% |
| 12 | Brazil | 2,577 | 3.1% |
| 13 | Iraq (OPEC) | 2,400 | 2.9% |
| 14 | Algeria (OPEC) | 2,126 | 2.6% |
| 15 | Nigeria (OPEC) | 2,211 | 2.7% |

In terms of oil reserves then these are dominated by a relatively small number of nations as shown below in Table 3 and in FIG. 1C. With the exception of Canada the vast majority of these oil reserves are associated with conventional oil fields. Canadian reserves being dominated by Athabasca oil sands which are large deposits of bitumen, or extremely heavy crude oil, located in northeastern Alberta, Canada. The stated reserves of approximately 170,000 billion barrels is based upon only 10% of total actual reserves, these being those economically viable to recover in 2006.

TABLE 3
Top 15 Oil Reserve Nations

| | Nation | Reserves (1000 bbl) | Share |
|---|---|---|---|
| 1 | Saudi Arabia | 264,600,000 | 19.00% |
| 2 | Canada | 175,200,000 | 12.58% |
| 3 | Iran | 137,600,000 | 9.88% |
| 4 | Iraq | 115,000,000 | 8.26% |
| 5 | Kuwait | 104,000,000 | 7.47% |
| 6 | United Arab Emirates | 97,800,000 | 7.02% |
| 7 | Venezuela | 97,770,000 | 7.02% |
| 8 | Russia | 74,200,000 | 5.33% |
| 9 | Libya | 47,000,000 | 3.38% |
| 10 | Nigeria | 37,500,000 | 2.69% |
| 11 | Kazakhstan | 30,000,000 | 2.15% |
| 12 | Qatar | 25,410,000 | 1.82% |
| 13 | China | 20,350,000 | 1.46% |
| 14 | United States | 19,120,000 | 1.37% |
| 15 | Angola | 13,500,000 | 0.97% |

Therefore in the vast majority of wells are drilled into oil reservoirs to extract the crude oil. “Natural lift” production methods that rely on the natural reservoir pressure to force the oil to the surface are usually sufficient for a while after reservoirs are first tapped. In some reservoirs, such as in the Middle East, the natural pressure is sufficient over a long time. The natural pressure in many reservoirs, however, eventually dissipates. Then the oil must be pumped out using “artificial lift” created by mechanical pumps powered by gas or electricity. Over time, these “primary” methods become less effective and “secondary” production methods may be used. A common secondary method is “waterflood” or injection of water into the reservoir to increase pressure and force the oil to the drilled shaft or “wellbore.” Eventually “tertiary” or “enhanced” oil recovery methods may be used to increase the oil's flow characteristics by injecting steam, carbon dioxide and other gases or chemicals into the reservoir. In the United States, primary production methods account for less than 40% of the oil produced on a daily basis, secondary methods account for about half, and tertiary recovery the remaining 10%.

An oil well is created by drilling a hole 5 to 50 inches (127.0 mm to 914.4 mm) in diameter into the earth with a drilling rig that rotates a drill string with a bit attached. After the hole is drilled, sections of steel pipe (casing), slightly smaller in diameter than the borehole, are placed in the hole. Cement may be placed between the outside of the casing and the borehole to provide structural integrity and to isolate high pressure zones from each other and from the surface. With these zones safely isolated and the formation protected by the casing, the well can be drilled deeper, into potentially more unstable formations, with a smaller bit, and also cased with a smaller size casing. Typically wells have two to five sets of subsequently smaller hole sizes drilled inside one another, each cemented with casing.

During drilling, the drill bit, aided by the weight of thick walled pipes called “drill collars” above it, cuts into the rock and drilling fluid, commonly referred to as “mud”, is pumped down the inside of the drill pipe and exits at the drill bit. Drilling mud is a complex mixture of fluids, solids and chemicals that must be carefully tailored to provide the correct physical and chemical characteristics required to safely drill the well. Particular functions of the drilling mud include cooling the bit, lifting rock cuttings to the surface, preventing destabilisation of the rock in the wellbore walls and overcoming the pressure of fluids inside the rock so that these fluids do not enter the wellbore.

Watching for abnormalities in the returning cuttings and monitoring pit volume or rate of returning fluid are imperative to catch “kicks” early. A “kick” is when the formation pressure at the depth of the bit is more than the hydrostatic head of the mud above, which if not controlled temporarily by closing the blowout preventers and ultimately by increasing the density of the drilling fluid would allow formation fluids and mud to come up through the drill pipe uncontrollably. The pipe or drill string to which the bit is attached is gradually lengthened as the well gets deeper by screwing in additional 30-foot (9 m) sections or “joints” of pipe under the kelly or topdrive at the surface.

After drilling and casing the well, it must be ‘completed’. Completion is the process in which the well is enabled to produce oil or gas. In a cased-hole completion, small holes called perforations are made in the portion of the casing which passed through the production zone, to provide a path for the oil to flow from the surrounding rock into the production tubing. Finally, the area above the reservoir section of the well is packed off inside the casing, and connected to the surface via a smaller diameter pipe called tubing. This arrangement provides a redundant barrier to leaks of hydrocarbons as well as allowing damaged sections to be replaced. Also, the smaller cross-sectional area of the tubing produces reservoir fluids at an increased velocity in order to minimize liquid fallback that would create additional back pressure, and shields the casing from corrosive well fluids.

In many wells, the natural pressure of the subsurface reservoir is high enough for the oil or gas to flow to the surface. However, this is not always the case, especially in depleted fields where the pressures have been lowered by other producing wells, or in low permeability oil reservoirs. Installing smaller diameter tubing may be enough to help the production, but artificial lift methods may also be needed. Common solutions include downhole pumps, gas lift, or surface pump jacks.

The production stage is the most important stage of a well's life, when the oil and gas are produced. By this time, the oil rigs and workover rigs used to drill and complete the well have moved off the wellbore, and the top is usually outfitted with a collection of valves called a Christmas tree or Production tree. These valves regulate pressures, control flows, and allow access to the wellbore in case further completion work is needed. From the outlet valve of the production tree, the flow can be connected to a distribution network of pipelines and tanks to supply the product to refineries, natural gas compressor stations, or oil export terminals. As long as the pressure in the reservoir remains high enough, the production tree is all that is required to produce the well. If the pressure depletes and it is considered economically viable, an artificial lift method mentioned in the completions section can be employed.

As outlined above the downhole fluid pressures are controlled in modern wells through the balancing of the hydrostatic pressure provided by the mud used. Should the balance of the drilling mud pressure be incorrect then formation fluids (oil, natural gas and/or water) begin to flow into the wellbore and up the annulus (the space between the outside of the drill string and the walls of the open hole or the inside of the last casing string set), and/or inside the drill pipe. This is commonly called a kick. If the well is not shut in (common term for the closing of the blow-out preventer valves), a kick can quickly escalate into a blowout when the formation fluids reach the surface, especially when the influx contains gas that expands rapidly as it flows up the wellbore, further decreasing the effective weight of the fluid. Additional mechanical barriers such as blowout preventers (BOPs) can be closed to isolate the well while the hydrostatic balance is regained through circulation of fluids in the well.

A kick can be the result of improper mud density control, an unexpected over-pressured gas pocket, or may be a result of the loss of drilling fluids to a formation called a thief zone. If the well is a development well, these thief zones should already be known to the driller and the proper loss control materials would have been used. However, unexpected fluid losses can occur if a formation is fractured somewhere in the open-hole section, causing rapid loss of hydrostatic pressure and possibly allowing flow of formation fluids into the wellbore. Shallow over-pressured gas pockets are generally unpredictable and usually cause the more violent kicks because of rapid gas expansion almost immediately.[citation needed]

The first response to detecting a kick would be to isolate the wellbore from the surface by activating the blow-out preventers and closing in the well. Then the drilling crew would attempt to circulate in a heavier kill fluid to increase the hydrostatic pressure (sometimes with the assistance of a well control company). In the process, the influx fluids will be slowly circulated out in a controlled manner, taking care not to allow any gas to accelerate up the wellbore too quickly by controlling casing pressure with chokes on a predetermined schedule.

In a simple kill, once the kill-weight mud has reached the bit the casing pressure is manipulated to keep drill pipe pressure constant (assuming a constant pumping rate); this will ensure holding a constant adequate bottom hole pressure. The casing pressure will gradually increase as the contaminant slug approaches the surface if the influx is gas, which will be expanding as it moves up the annulus and overall pressure at its depth is gradually decreasing. This effect will be minor if the influx fluid is mainly salt water. And with an oil-based drilling fluid it can be masked in the early stages of controlling a kick because gas influx may dissolve into the oil under pressure at depth, only to come out of solution and expand rather rapidly as the influx nears the surface. Once all the contaminant has been circulated out, the casing pressure should have reached zero.

Sometimes, however, companies drill underbalanced for better, faster penetration rates and thus they “drill for kicks” as it is more economically sound to take the time to kill a kick than to drill overbalanced (which causes slower penetration rates).

In deep subsea applications, a number of problems may arise. Firstly, because of the pressures involved, everything becomes significantly more complicated. The pressure that bears down on the formation includes the weight of the drilling mud, whereas the pressure in the shallow formations is dictated by the weight of seawater above the formation. Because of the higher pressures involved, the drilling mud may actually be injected into the formation, fracture it and may even clog or otherwise foul the formation itself, severely impairing potential production.

Within the prior art there are disclosed a wide variety of blowout (or blow out) preventers (BOPs) and tubular-shearing blades for BOPs. Typical BOPs have selectively actuatable rams housings secured to the body which are either pipe rams (to contact, engage, and encompass the pipe and/or tools to seal a wellbore) or shear rams (to contact and physically shear a tubular, casing, pipe or tool used in wellbore operations). Rams typically upon activation and subsequent shearing of a tubular, are designed to seal against each other over a center of a wellbore so that the pipe is sealed.

BOPs and tubular-shearing blades for them are disclosed in many U.S. patents, including, but not limited to, U.S. Pat. Nos. 2,752,119; 3,272,222; 3,554,278; 3,561,526; 3,692,316; 3,736,982; 3,744,749; 3,817,326; 3,827,668; 3,863,667; 3,946,806; 3,955,622; 4,043,389; 4,057,887; 4,081,027; 4,132,265; 4,132,267; 4,313,496; 4,253,638; 4,347,898; 4,476,935; 4,492,359, 4,504,037, 4,523,639, 4,537,250; 4,540,046; 4,550,895; 4,554,976; 4,558,842; 4,646,825; 4,923,005; 4,923,008; 4,969,390; 5,013,005; 5,025,708; 5,056,418; 5,360,061; 5,400,857; 5,505,426; 5,515,916; 5,529,127; 5,575,451; 5,575,452; 5,653,418; 5,655,745; 5,713,581; 5,918,851; 5,979,943; 6,044,690; 6,158,505; 6,173,770; 6,244,336; 7,032,691; 7,207,382; 7,234,530; 7,354,026; 7,367,396; 7,703,739; and 7,814,979 as well as US Patent Application Nos. 2005/0,092,522; 2006/0,021,749; 2006/0,038,147; 2006/0,090,899; 2006/0,144,586; 2006/0,191,716; 2008/0,001,107; 2009/0,127,482; 2009/0,314,544; and 2010/0,319,906.

Blowouts, originally known as gushers were an icon of oil exploration during the late 19th and early 20th centuries, producing large amounts of oil, often shooting 200 feet (60 m) or higher into the air. Despite being originally symbols of new-found wealth, gushers are dangerous and wasteful. They can kill oil workers involved in drilling, destroy equipment including complete oil rigs, see for example Deepwater Horizon in Gulf of Mexico in April 2010, and coat the landscape with thousands or tens of thousands of barrels of oil per day. In addition, output of a well blowout might include sand, mud, rocks, drilling fluid, natural gas, water, and other substances. Blowouts will often be ignited by an ignition source, from sparks from rocks being ejected, or simply from heat generated by friction.

Whilst surface blowouts on oil wells drilled on land can be difficult to deal with it is very difficult to deal with a blowout in very deep water because of the remoteness and limited experience with this type of situation. Using the world's most authoritative database of oil rig accidents, a Norwegian company, Det Norske Veritas, focused on some 15,000 wells drilled off North America and in the North Sea from 1980 to 2006 in analyzing blowouts. They found 11 cases where crews on deepwater rigs had lost control of their wells and then activated BOPs to prevent a spill. In only six of those cases were the wells brought under control, leading the researchers to conclude that in actual practice, BOPs used by deepwater rigs had a “failure” rate of 45 percent.”

A 2002 study commissioned by the U.S. Minerals Management Service, the agency that oversees the offshore oil industry, found that 50 percent of the shear rams tested failed to cut through pipe and halt the flow of oil. Additionally the U.S. Minerals Management Service has identified 117 failures of BOPs during a two-year period in the late 1990s on the outer continental shelf of the United States. The unclassified version of the report identifying that the failures involved 83 wells drilled by 26 rigs in depths from 1,300 feet to 6,560 feet. A similar report released by the agency in 1997 found that between 1992 and 1996 there were 138 failures of BOPs on underwater wells being drilled off Brazil, Norway, Italy and Albania.

Shanks et al in “Deepwater BOP Control Systems—A Look at Reliability Issues” (2003 Offshore Technology Conference, Paper 15194) and considered the reliability of components within the BOP on the basis of a 5 year deployment and with regular testing. For offshore floating drilling operations, especially in deepwater, Shanks considered a BOP control system associated with dynamically positioned (DP) rigs is typically a Multiplexed Electro-Hydraulic (MUX) Control System as depicted in FIG. 1D. The demand on the subsea control system is initiated at the surface. The demand signal is multiplexed down the control umbilical to the subsea control system. There, the signal is decoded, confirmed, and performed. For a demand that requires a BOP Ram to close, for example, the multiplex signal would be received at the subsea control pod and decoded. The decoded signal would cause a solenoid to be opened electrically which would send a hydraulic pilot signal to the proper hydraulic valve. This pilot signal would cause the hydraulic valve to shift and send stored and pressurized hydraulic fluid to the BOP Ram to be closed.

Therefore, the subsea BOP control system consists of two basic elements: electrical and hydraulic components. Historically more subsea problems have been associated with the hydraulic components than the electrical. In routine production failures of a BOP may result in the BOP and riser being retrieved for repair resulting in significant revenue loss to the oil production company. In other instances these failures may lead to catastrophic consequences such as witnessed with the Deepwater Horizon disaster and the subsequent damage to marine ecosystems and economic damage to entire regions of the U.S. gulf coast.

Each subsea BOP system has two complete control pods. Each pod is capable of performing all necessary functions on the BOP. While these systems may be considered redundant, any major problem associated with one pod will cause the system to be retrieved to the surface for repair. If a major problem is found, the control of the subsea BOP is transferred to the other pod and preparations will be made to retrieve the lower marine riser package (LMRP) and riser to surface. Some minor problems may not require the system to be retrieved if considered not necessary for critical operations.

Shanks assessed the BOP as comprising 24 accumulators, 22 check valves, 6 pilot check valves, 38 dual action pilot valves, 42 single action pilot valves, 12 regulators, 74 shuttle valves and 142 solenoid valves. Based upon the 5 year deployment scenario and regular testing these accounted for over 87,000 operations subsea where at any point flawless operation in a real event would be required.

Accordingly it would be evident that existing BOP devices are complex electromechanical systems exploiting hydraulic activation of pipe rams and/or shear rams. With tens of thousands of oil wells in the 1,500 oil fields that account for 97% of global production of the over 40,000 oil fields identified to date and failure rates as high as 50% in disaster situations it is evident that a simpler, increased reliability approach would be beneficial to the oil and gas industries. It would be further beneficial if the BOP was automatic requiring no monitoring locally to the BOP or remotely from the rig or production facility.

BOPs according to the prior art with shear rams are single occurrence devices intended to shear and block the riser pipe. It would be beneficial if the BOP allowed multiple operations and reset under a relaxation of the pressure within the riser.

### SUMMARY OF THE INVENTION

It is an object of the present invention to mitigate one or more disadvantages of the prior art with respect to blowout preventers and more specifically to low complexity automatic blowout preventers.

In accordance with an embodiment of the invention there is provided a method comprising:
providing a ring assembly attached to the inner surface of a pipe comprising an opening of predetermined geometry;
providing a compliant structure, a first distal end abutting the ring assembly in a manner not restricting the opening and having a predetermined length versus force characteristic;
providing a plug assembly abutting a second distal end of the compliant structure and comprising a plug forming a predetermined portion of the plug assembly having an external geometry over a predetermined portion of the plug to fit in abutting relationship to the opening.

In accordance with an embodiment of the invention there is provided a method comprising:
a ring assembly attached to the inner surface of a pipe comprising an opening of predetermined geometry;
a compliant structure, a first distal end abutting the ring assembly in a manner not restricting the opening and having a predetermined length versus force characteristic;
a plug assembly abutting a second distal end of the compliant structure and comprising a plug forming a predetermined portion of the plug assembly having an external geometry over a predetermined portion of the plug to fit in abutting relationship to the opening.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures, wherein:

FIG. 1A depicts the geographical distribution of consumption globally;

FIG. 1B depicts the geographical distribution worldwide of oil production;

FIG. 1C depicts the geographical distribution worldwide of oil reserves;

FIG. 1D depicts a Multiplexed Electro-Hydraulic (MUX) Control System according to the prior art;

FIG. 2 depicts a BOP according to the prior art of Hynes in U.S. Pat. No. 4,476,935;

FIG. 3 depicts a shear ram according to the prior art of Whitby in U.S. Pat. No. 5,400,857;

FIG. 4 depicts a shear ram according to the prior art of Urrutia in US Patent Application 2006/0,144,586;

FIG. 5 depicts shear rams according to the prior art of Judge in U.S. Pat. No. 7,703,739;

FIG. 6 depicts a shear ram according to the prior art of van Winkle in US Patent Application 2010/0,319,906;

FIG. 7 depicts a BOP according to an embodiment of the invention;

FIG. 8 depicts a BOP plug according to an embodiment of the invention;

FIG. 9 depicts a BOP according to an embodiment of the invention;

FIG. 10 depicts a BOP plug according to an embodiment of the invention;

FIG. 11 depicts a BOP according to an embodiment of the invention;

FIG. 12 depicts a BOP according to an embodiment of the invention used in conjunction with a pressure blowout element;

FIG. 13 depicts a BOP according to an embodiment of the invention in conjunction with a flow director element;

FIG. 14 depicts a BOP according to an embodiment of the invention in conjunction with a flow director element wherein the BOP and flow director element can be programmed to operate at different pressures;

FIG. 15 depicts a BOP according to an embodiment of the invention;

FIG. 16 depicts a BOP according to an embodiment of the invention allowing a drill string to be operated through the BOP;

FIG. 17 depicts a BOP according to an embodiment of the invention allowing a drill string to be operated through the BOP;

FIG. 18 depicts a BOP according to an embodiment of the invention allowing a drill string to be operated through the BOP;

FIG. 19 depicts a BOP according to an embodiment of the invention allowing a drill string to be operated through the BOP;

FIG. 20 depicts a cascaded BOP according to an embodiment of the invention allowing a drill string to be operated through the BOP; and

FIG. 21 depicts a BOP according to an embodiment of the invention allowing a drill string to be operated through the BOP.

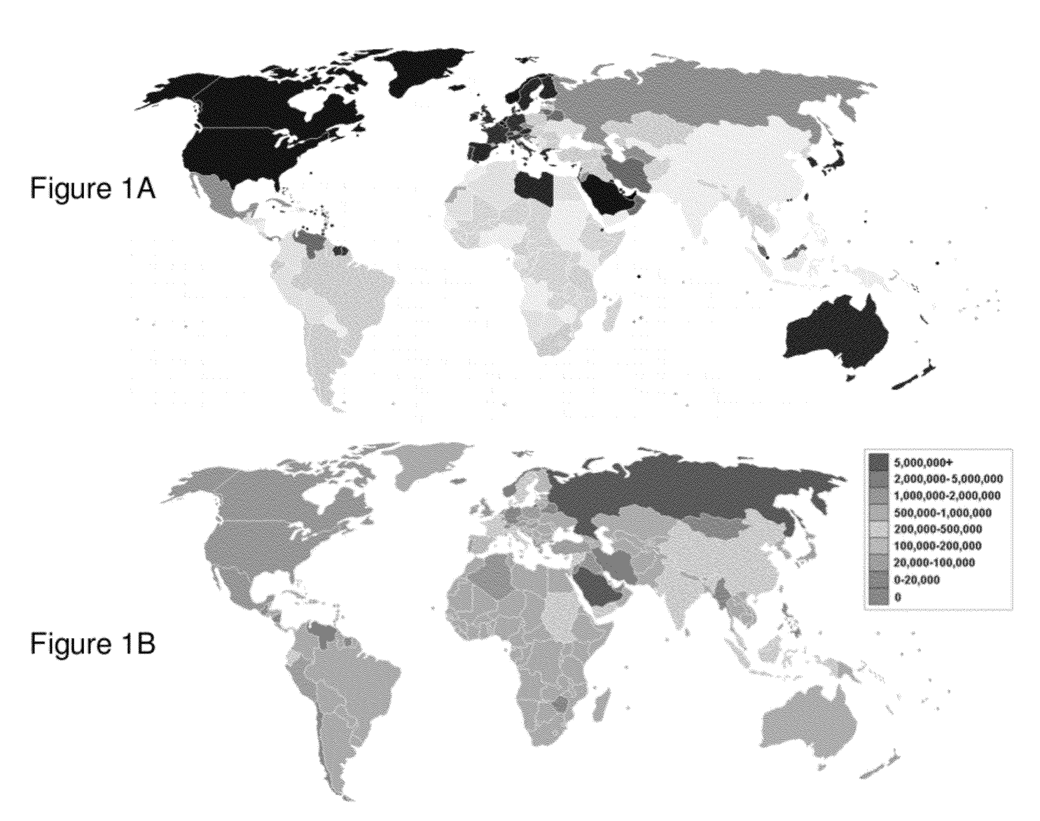

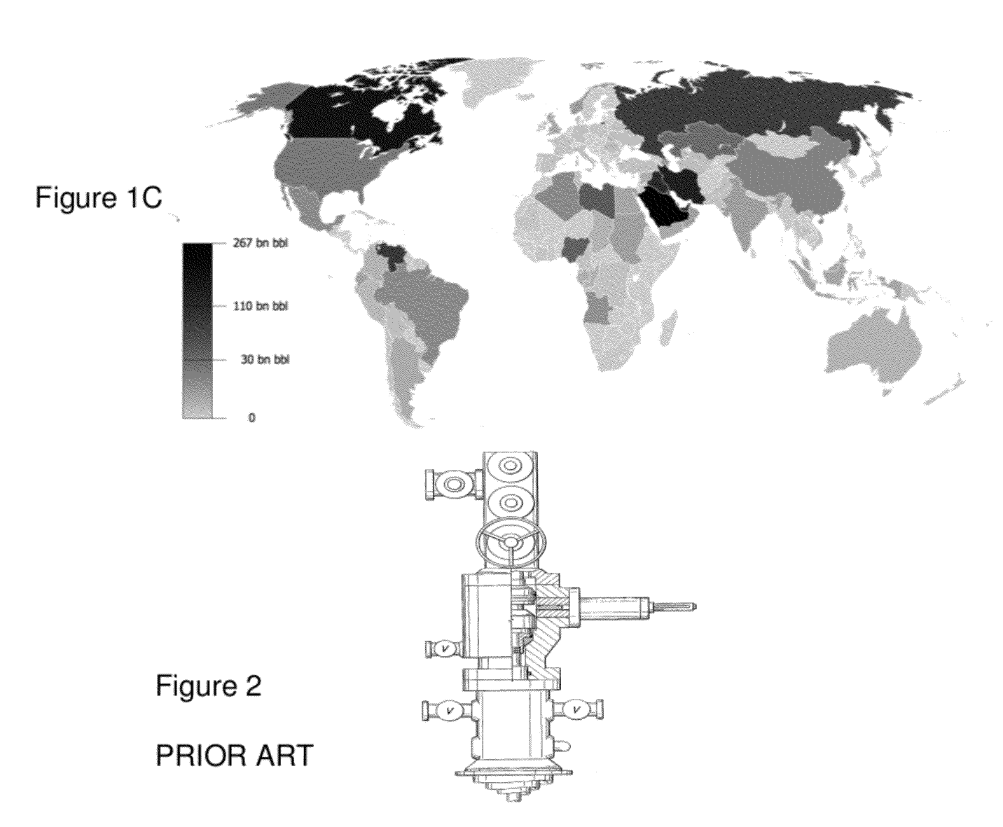

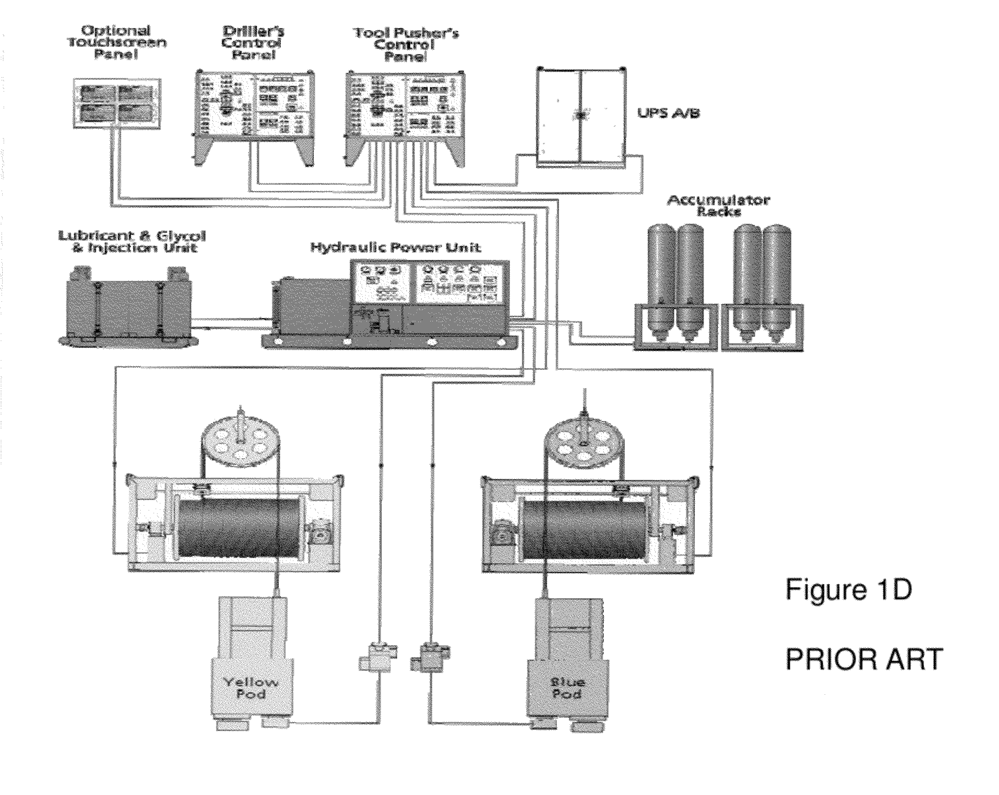

### DETAILED DESCRIPTION

The present invention is directed to blowout preventers and more specifically to low complexity automatic blowout preventers.

FIG. 2 depicts a BOP according to the prior art of Hynes in U.S. Pat. No. 4,476,935. Accordingly a production BOP 10 is shown after production tubing and other apparatus has been inserted into the well through the BOP stack 11 and after a production tree 13 has been attached for controlling the production of gas and fluid from the well. A tubular extension may be provided between the production tree 13 and the blowout preventer 10 providing a safe distance between the tree 13 and its valves which may leak and be subject to a fire and the production blowout preventer 10 which is adapted to close off flow in production tubing during an emergency. A tubular extension also allows the blowout preventer to be located on a lower deck and the production tree on an upper deck as is common on offshore production platforms.

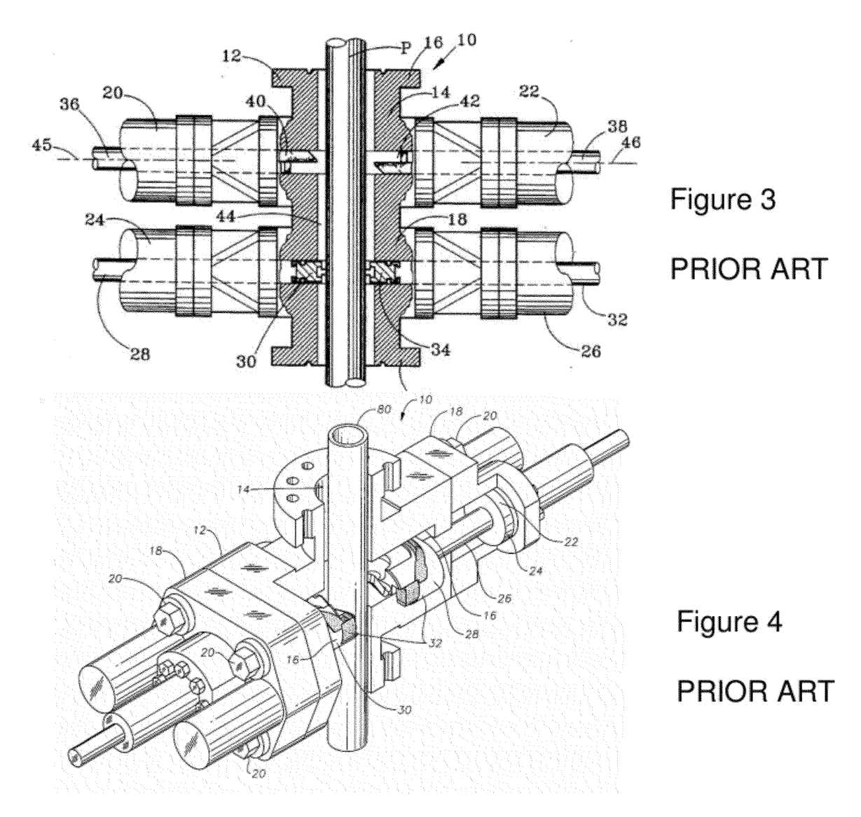

FIG. 3 depicts a shear ram according to the prior art of Whitby in U.S. Pat. No. 5,400,857 wherein a shearing assembly 10 which may comprise a blowout preventer body 12 having an upper portion 14 for receiving shearing ram subassemblies discussed subsequently, and a lower portion 18 for receiving sealing ram subassemblies also discussed subsequently. The body portions 14 and 18 may be formed separately or as an integral member, and include an upper flange 16 and a lower flange 17 for sealed engagement with related wellhead equipment conventionally mounted to the BOP body 12. The body 12 of the shearing assembly 10 includes a vertical through bore 44 having a generally cylindrical configuration, and that the oilfield tubular member or pipe P as shown in FIG. 3 passes through this bore in a conventional manner while the tubular is run in or pulled out of the wellbore.

A pair of upper shear ram subassemblies 20 and 22 are mounted to the upper body 12, with each shear ram subassembly including a respective piston 36 and 38 for moving respective shear blades 40 and 42 linearly from an open position to a closed position. Each ram subassembly 20 and 22 may be powered by a hydraulic fluid source which simultaneously moves the shear blades 40 and 42 radially inward and outward. A suitable fluid power source for linearly moving the ram pistons 36 and 38 within the subassemblies 20 and 22 is disclosed in U.S. Pat. No. 4,923,008. Except for the configuration of the shearing blades, the ram subassemblies 20 and 22 may be of the type conventionally utilized in blowout preventers. The assembly 10 also includes opposing lower sealing ram subassemblies 24 and 26, which are similarly fluid powered and include ram pistons Z8 and 32 each powering a respective sealing assembly 30 and 34. The pistons 28 and 32 and the sealing assemblies 30 and 34 are of the type which are conventionally used in blowout preventers, and further details regarding such equipment are disclosed in U.S. Pat. No. 3,590,920. The upper ram pistons 36 and 38 may be simultaneously activated for shearing the tubular P in an emergency, but that normally the shear blades 40 and 42 are retracted into the body of the BOP, as shown in FIG. 3.

The lower sealing assemblies 24 and 26 may similarly be retracted into the body of BOP as the tubular is passed through the cylindrical bore 44, although the pistons 28 and 32 may be simultaneously activated at selected times to move the respective sealing assemblies 30 and 34 radially inward and into sealing engagement with the pipe P as shown in FIG. 3, so that the annulus between the pipe and the body 12 of the assembly is reliably sealed. In a typical application, the assembly as shown in FIG. 3 may be part of a subsea wellhead assembly, with the pipe P extending from a ship into a wellbore beneath the seabed. During a storm or other emergency, it may be necessary for the rig to be structurally released quickly from the wellhead, in which case the upper ram assemblies 20 and 22 may be activated for shearing the pipe P.

FIG. 4 depicts a shear ram according to the prior art of Urrutia in US Patent Application 2006/0,144,586 wherein an isometric view of a ram type blowout preventer 10 used in oil and gas drilling operations is shown. The ram type blowout preventer 10 includes a body or housing 12 with a vertical bore 14 and laterally disposed ram guideways 16. Bonnet assemblies 18 are mounted to the body 12 with bolts 20 and aligned with laterally disposed guideways 16. Each bonnet assembly 18 includes an actuation means 22, including a piston 24 and connecting rod 26. While only one guideway 16 and actuation means 22 is shown, it is understood by those of ordinary skill in the art that there is a pair of opposed guideways 16 and actuation means 22. Connecting rods 26 are connected to upper ram assembly 28 and lower ram assembly 30 to form shearing blind ram assembly 32. Actuation means 22 allows shearing blind ram assembly 32 to be reciprocated within guideways 16.

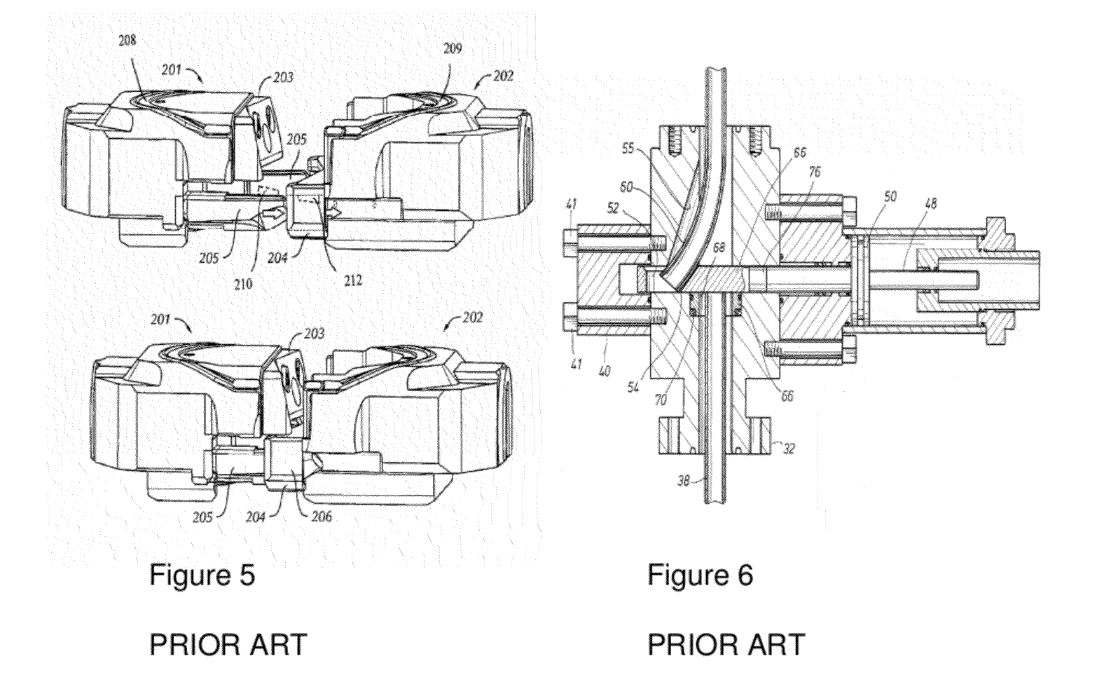

FIG. 5 depicts shear rams according to the prior art of Judge in U.S. Pat. No. 7,703,739 in a perspective view. Ram blocks 201, 202 are shown separate from a BOP for ease of understanding. Second ram block 202 includes a connector 211 where the ram block 202 may be connected to a driving rod or piston (not shown) or other device for forcing the ram block 202 into a closed position. A similar connector (not shown) may be present on the first ram block 201. Still referring to FIG. 5, ram blocks 201, 202 comprise shear elements 203, 204, respectively, which are attached to a vertical face of each ram block 201, 202. Shear elements 203, 204 are configured to engage when the BOP is in a closed position thereby shearing any piping or tools in the wellbore as well as sealing it off. Further, the ram blocks 201 and 202 include seal elements 208 and 209. Furthermore, first ram block 201 comprises load intensifying members 205 configured to engage rectangular receptacles (not shown) on ram block 202. While receptacles are described as rectangular, other appropriate configurations may be used.

FIG. 6 depicts a shear ram according to the prior art of van Winkle in US Patent Application 2010/0,319,906 wherein the BOP comprises a body 32 with a bore 34 oriented along an axis 36. Coiled tubing 38 is positioned through the BOP aligned along the axis 36. Bolted to the side of the body 32 is a ram-receiving chamber 40 mounted to the body 32 with a set of mounting bolts 41 or other appropriate means. Opposite the ram-receiving chamber 40 is a bonnet which is arranged to support and guide the operable components of the shear/seal ram portion of the BOP. The bonnet may be mounted to the body with a plurality of bolts or other appropriate means. The bonnet defines a bore there through which is adapted to receive a ram 76 operatively coupled to a rod 48 which is moved transversely back and forth by a piston 50 retained within a cylinder.

The BOP may include a self-contained hydraulic cylinder system to open and close the bonnet of the BOP to replace rams in the field. Actuation of the hydraulic cylinder system pulls the bonnet back away from the body 32, bringing the ram 76 with it, so that the ram can be changed. The body also defines a severed tubing receiving cavity 54 which defines an angled upper surface 56. The cavity 54 provides a volume to receive the upper portion of the severed coiled tubing. The ram includes a ram bore 52 such that when the shear/seal ram is in the open position the coiled tubing 38 passes through the ram bore 52. The ram bore 52 also defines a knife edge 54 in operable position to shear the coiled tubing when the shear seal ram is actuated. As the knife edge 54 shears the coiled tubing, the upper portion of the coiled tubing is moved to the left into the cavity 54. The bore 52 forms a knife edge 54 with a pair of opposing substantially straight edges 55 which provide a guillotine action against the coiled tubing when the ram is shut. Once the ram is shut, if pressure is higher below the ram than above the ram, a shear seal ring 66 is pressed against an underside 68 of the ram to seal in the pressure under the ram within an annulus 69. The seal ring 66 is spring loaded by a Bellville spring 70 which is supported on a shoulder 72 extending outwardly from the bore 13.

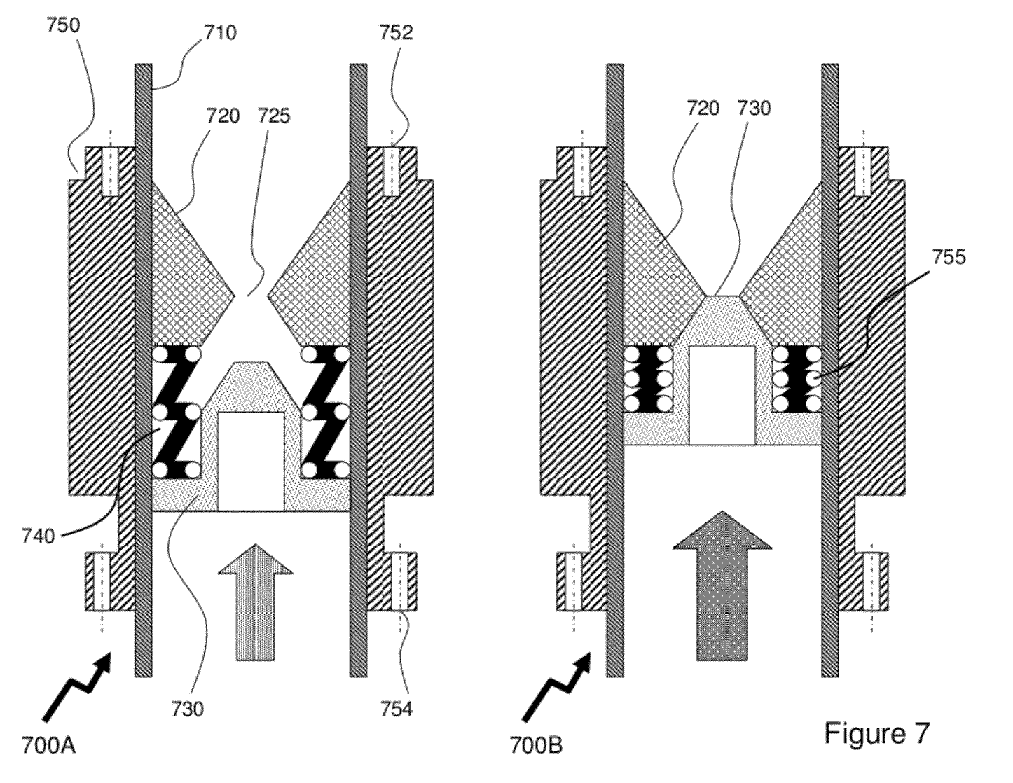

FIG. 7 depicts a BOP according to an embodiment of the invention in open 700A and closed 700B states. Referring to open 700A a riser 710 is depicted surrounded by a casing 750 having upper and lower threaded holes 752 and 754 allowing the casing 750 to be mounted to structures above and below respectively such as other portions of a production tree for example. Disposed with the riser 710 is annular ring 720 and plug 730 wherein there are disposed springs 740 between the lower surface of the annular ring 720 and upper surface of the plug 730. Within the descriptions of the embodiments of the invention upper and lower shall be employed with respect to the cross-sectional view as portrayed with the oil reservoir below the structure as shown with flow upwards towards the production/drilling rig above the structure as shown. Accordingly when the oil pressure is low the springs 740 are uncompressed and the oil flows through the plug 730 from the oil reservoir to the rig above.

Under increased pressure, at a pressure exceeding the design specification of the BOP the pressure from the oil is sufficient to push the plug 730 compressing the springs 720 such that the plug 730 fits within the opening 725 of the annular ring 720 sealing it, as shown in closed 700B. Accordingly, it would be evident that if the pressure reduces the plug 730 will be returned towards its fully open state by the springs 720. As such the BOP provides a limiting function, restricting oil flow as pressure increases, and stop function when the pressure exceeds a predetermined threshold.

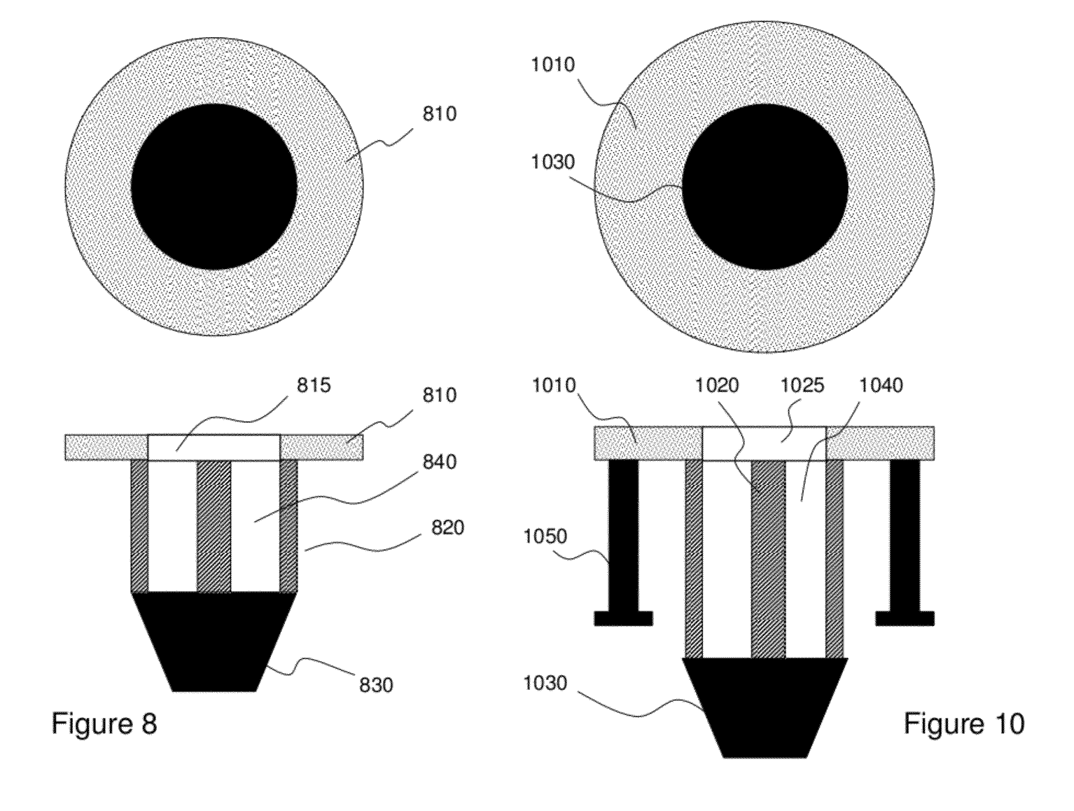

Referring to FIG. 8 there is depicted a BOP plug such as plug 730 described above in respect of FIG. 7. According to an embodiment of the invention the BOP plug comprises a solid bottom 830, designed to mate with the opening within the annular ring, for example opening 725 of annular ring 720, and an upper ring 810 which engages on the lower side as shown the springs of the BOP and the upper side provides part of the surface defining the force that is applied to the BOP plug by the oil. The plug 830 is connected to the upper ring 810 by a series of members 820. Accordingly oil may flow through the opening 815 in the upper ring 810 and then the openings 840 between the members 820.

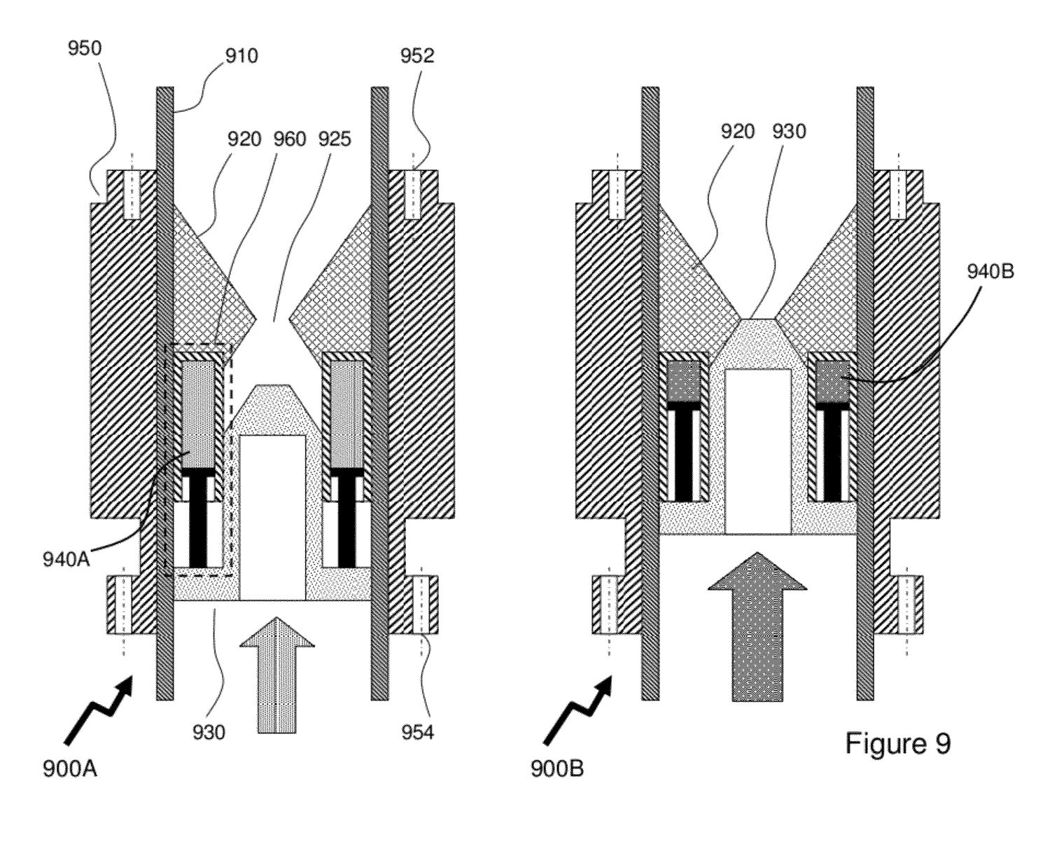

Now referring to FIG. 9 there is depicted a BOP according to an embodiment of the invention in open 900A and closed 900B states. Referring to open 900A a riser 710 is depicted surrounded by a casing 950 having upper and lower threaded holes 952 and 954 allowing the casing 950 to be mounted to structures above and below respectively such as other portions of a production tree for example. Disposed with the riser 910 is annular ring 920 and plug 930 wherein there are disposed buffers 960 between the lower surface of the annular ring 920 and upper surface of the plug 930. Within the buffers 960 is disposed a compressible material at a predetermined volume. Accordingly when the oil pressure is low the buffers 940 are uncompressed and the oil flows through the plug 930 from the oil reservoir to the rig above.

Under increased pressure, at a pressure exceeding the design specification of the BOP the pressure from the oil is sufficient to push the plug 930 compressing the compressible materials within the buffers 720 such that the plug 930 fits within the opening 925 of the annular ring 920 sealing it, as shown in closed 900B. Accordingly, it would be evident that if the pressure reduces the plug 930 will be returned towards its fully open state by the buffers 920. As such the BOP provides a limiting function, restricting oil flow as pressure increases, and stop function when the pressure exceeds a predetermined threshold.

Referring to FIG. 10 there is depicted a BOP plug such as plug 930 described above in respect of FIG. 9. According to an embodiment of the invention the BOP plug comprises a solid bottom 1030, designed to mate with the opening within the annular ring, for example opening 925 of annular ring 920, and an upper ring 1010 which has formed upon the lower surface plungers forming part of the buffers. The upper surface of the upper ring 1010 and bottom 1030 provide the surfaces defining the force that is applied to the BOP plug by the oil. The plug 1030 is connected to the upper ring 1010 by a series of members 1020. Accordingly oil may flow through the opening 1015 in the upper ring 1010 and then the openings 1040 between the members 1020.

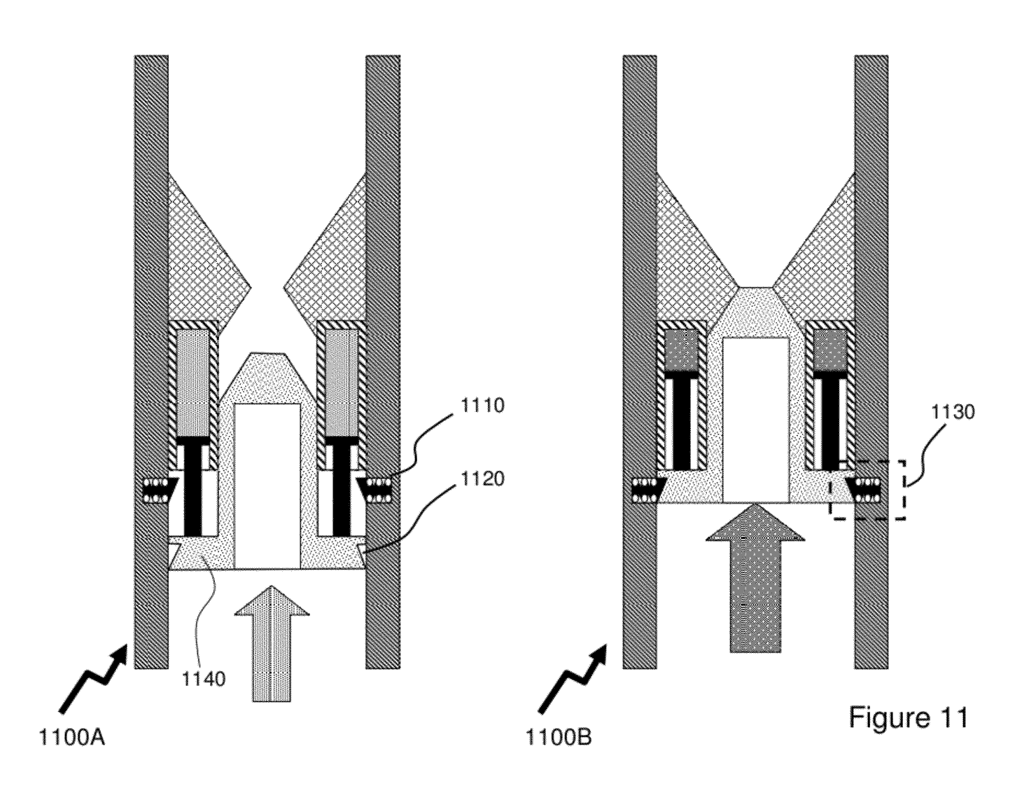

Referring to FIG. 11 there is depicted a BOP according to an embodiment of the invention in open and closed states 1100A and 1100B respectively. In overall construction the BOP is of similar construction to the BOP depicted supra in respect of FIG. 9. However the ring 1140 now has a continuous recess 1120 around the edge or at predetermined points around the outer edge. Similarly the riser now contains a sprung wedge 1110. Accordingly as the BOP moves from open 1100A to closed 1100B the sprung wedges 1110 is pushed back into the riser until the plug is sitting in the opening wherein the sprung wedges 1110 release so that they are within the recess 1120. By appropriate design of the sprung wedge 1110 and recess 1120 the movement of the plug pushes the sprung wedge 1110 into the riser as the oil pressure increases but once sprung into the recess 1120 reduction in oil pressure and action of the buffer is not able to push the spring wedge 1110 back into the riser again. For example the upper surface of the sprung wedge may be substantially parallel to the lower surface of the outer ring of the plug whilst the lower surface tapers allowing the plug to slide along.

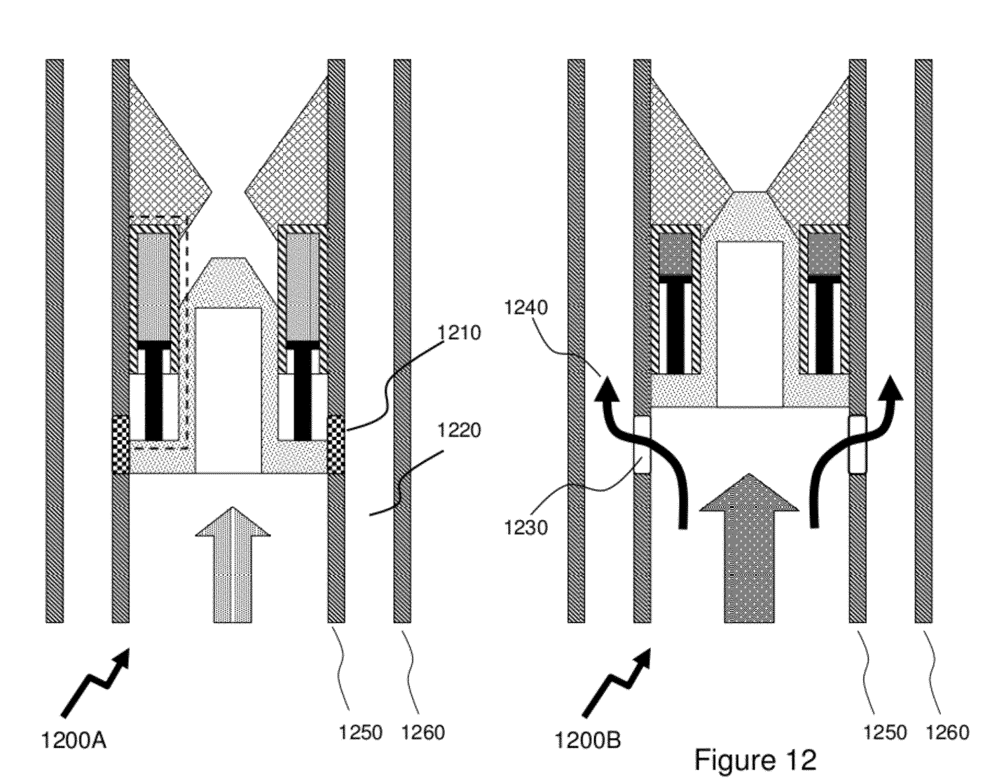

Now referring to FIG. 12 there is depicted a BOP according to an embodiment of the invention used in conjunction with a pressure blowout element 1210. Accordingly there is shown inner riser 1250 and outer riser 1260. Disposed within the inner riser 1250 is a BOP such as described supra in respect of FIG. 10 using buffers. Also disposed within the wall of inner riser 1250 are pressure blowout elements 1220. At low pressure the BOP is open and oil flows. As pressure rises the BOP begins to close and then closes. Subsequently as the pressure increases still further the pressure blowout elements 1220 rupture allowing the oil to flow into the region between inner liner 1250 and outer liner 1260. Accordingly recovery of the oil from the reservoir can then proceed to be restored.

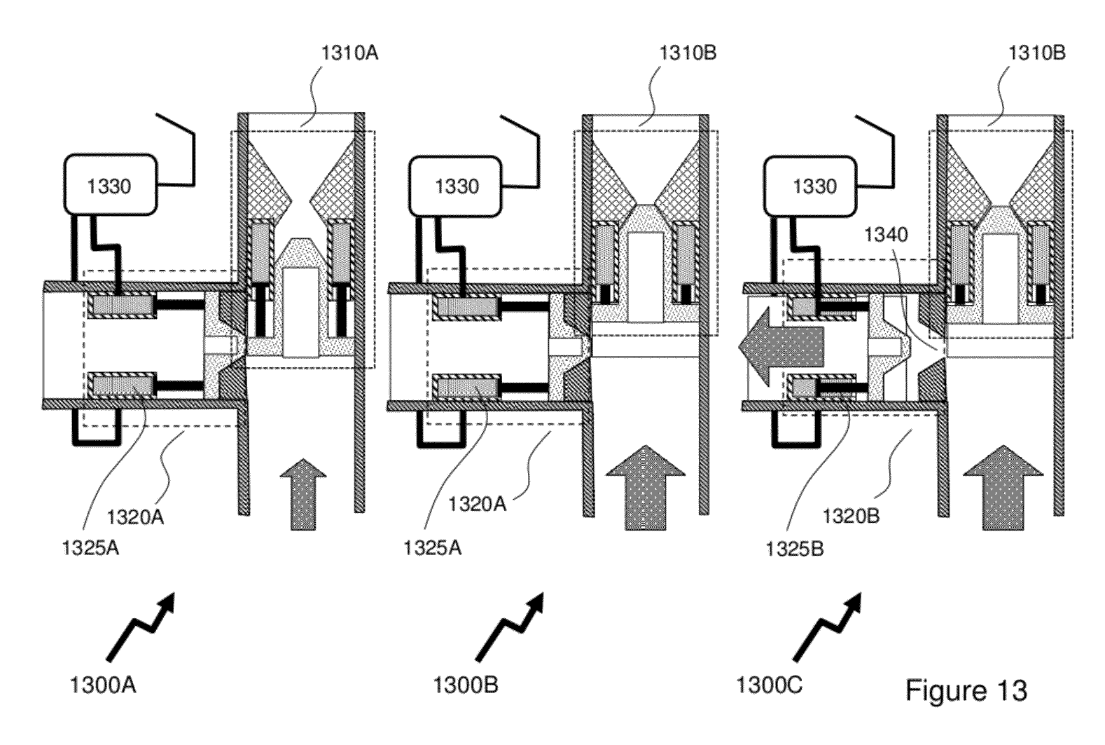

Referring to FIG. 13 there is depicted a BOP according to an embodiment of the invention in conjunction with a flow director element wherein the BOP is shown in normal 1300A, closed 1300B and bypass 1300C states. Accordingly a pressure initiated riser closer, shown as open closer 1310A and closed closer 1310B respectively in these three states, is disposed within a vertical riser wherein oil flows or is intended to flow. Pressure initiated riser closer for example being as depicted above in respect of FIGS. 9 and 11. In normal 1300A the pressure initiated riser closer is shown in its open state as open 1310 allowing flow of liquid from the oil reservoir up through the riser to the drilling/production rig. Disposed to the side of the riser just below the pressure initiated riser closer is a relief valve shown as closed valve 1320A and open valve 1320B in the three states. As shown the relief valve is of a hydraulic form wherein hydraulic rams maintain the position of a plug into the opening 1340 in the riser. The hydraulic rams being in engaged position 1325A when the relief valve is in the closed state and reduced state 1325B when the relief valve is in the open state. The hydraulic rams being coupled to hydraulic control system 1330.

When pressure in the riser increases above the predetermined limit of the drilling/production system, represented by closed 1300B, the pressure initiated riser closer transitions to a closed state as shown by closed closer 1310B. At this point the relief valve is also in its closed position as shown by closed valve 1320A, the default condition for the relief valve and associated hydraulic control system 1330. If the pressure in the riser reduces below the predetermined closing pressure then the pressure initiated riser closer will re-open allowing liquid to reflow vertically. As such pressure initiated riser closers according to embodiments of the invention may automatically close in the event of a kick.

Upon issuance of a relief command being sent to the hydraulic control system 1330 the hydraulic pressure within the hydraulic rams may be controllably reduced thereby allowing the pressure of the liquid to push the plug and open the flow of liquid into the second piping system attached to the relief valve but not shown for clarity. As such the hydraulic rams transition to disengaged state 1325B and the relief valve is now open valve 1320B.

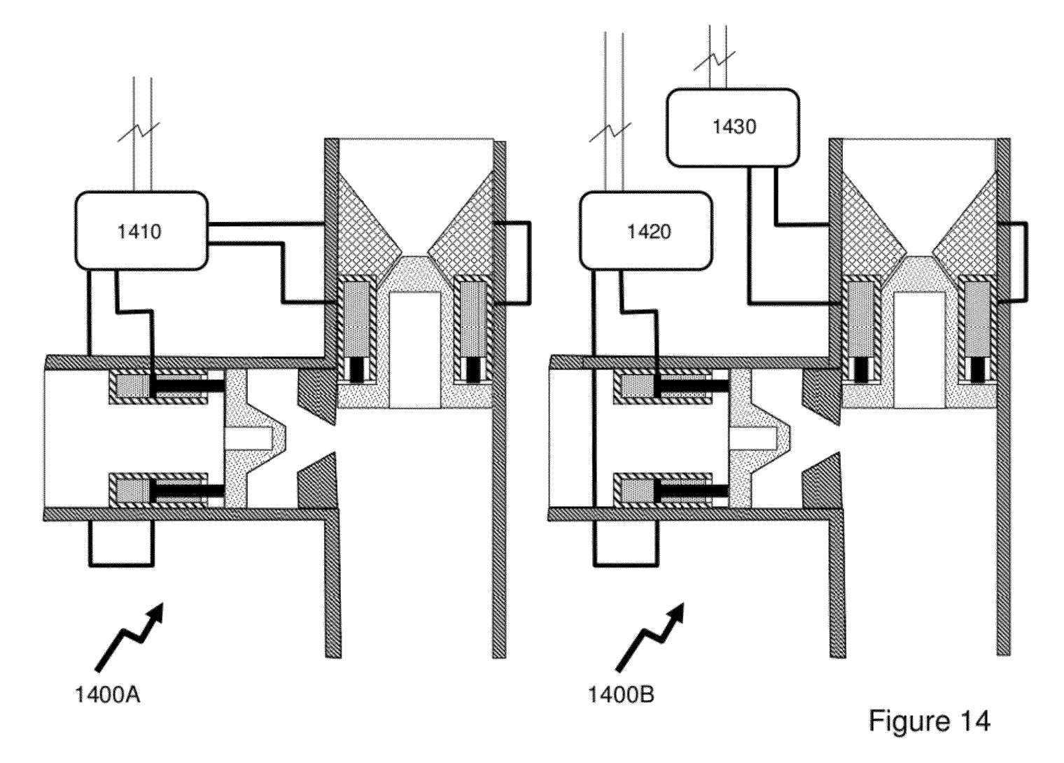

Optionally the buffers, such as buffers 960, in the pressure initiated riser closer may also be hydraulic rams. In a common configuration all the hydraulic rams are controlled from a single control system 1410 as depicted in first configuration 1400A of FIG. 14 or coupled to separate hydraulic controllers 1420 and 1430 as shown in second configuration 1400B of FIG. 14. It would be evident to one skilled in the art that by introducing such control systems the liquid pressure at which the BOP triggers may be adjusted or reset. Accordingly, if a kick is detected the BOP may be triggered allowing time for the mud pressure to be increased before adjusting the BOP hydraulic pressures allow the BOP to re-open in a slow controlled manner.

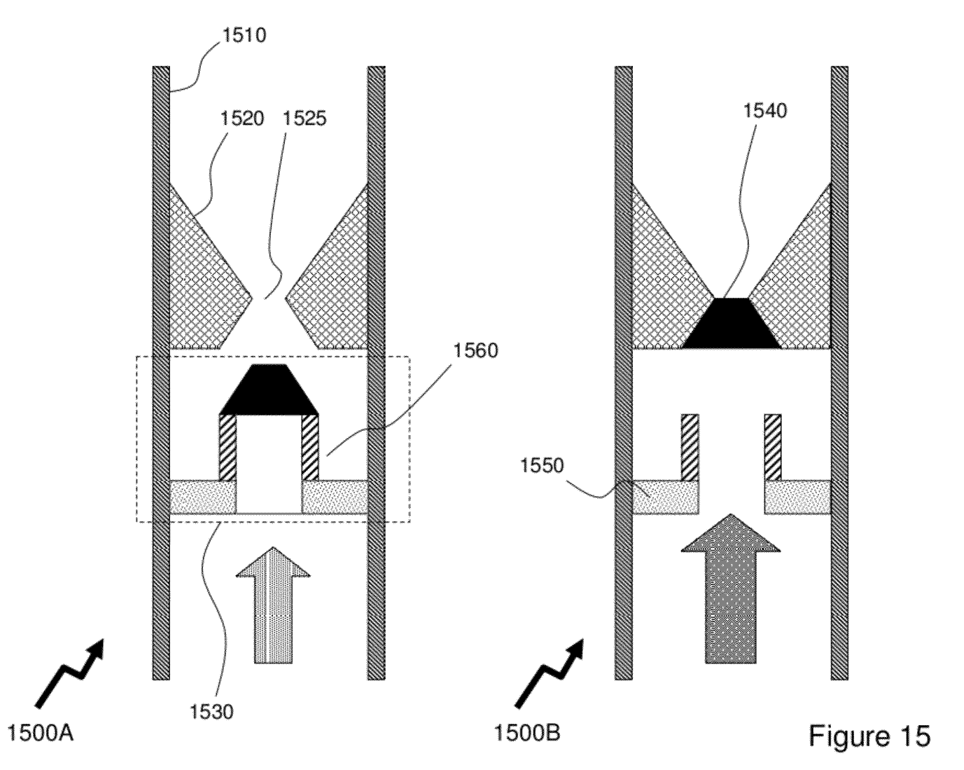

Referring to FIG. 15 there is presented a BOP according to an embodiment of the invention wherein a plug assembly 1530 is disposed within a riser 1510 in conjunction with an annular ring 1520 that provides an opening 1525. Plug assembly 1530 for example being of a similar design to the plug presented supra in FIG. 8 but the upper ring 1550 is now affixed to the inside of the riser 1510. Accordingly at low liquid pressure as depicted in normal configuration 1500A the plug assembly 1530 is fixed in place and the liquid flows through it and through the opening 1525. However, as the liquid pressure increases the force applied to plug 1540 of the plug assembly 1530 increases until a predetermined threshold is reached at which point the members 1560 between the plug 1540 and upper ring 1550 shear releasing the plug 1540 that is then pushed into the opening 1525 sealing it. This being shown in stopped configuration 1550B in FIG. 15.

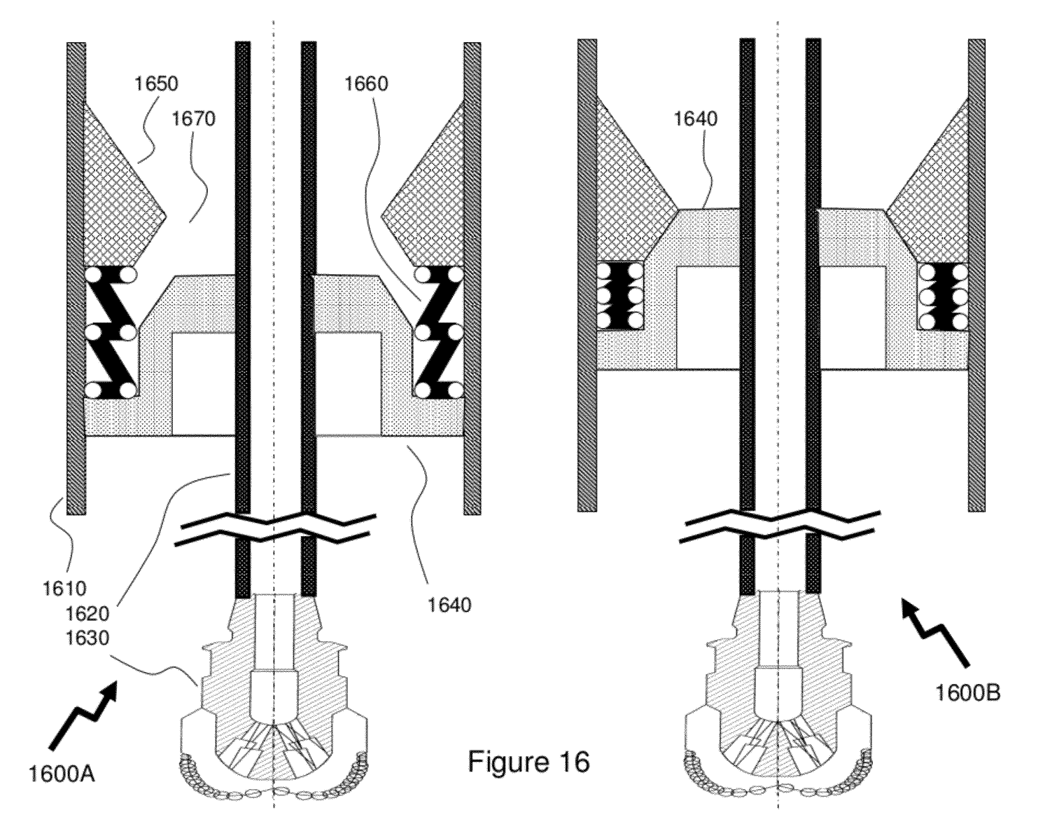

Now referring to FIG. 16 there is depicted a BOP according to an embodiment of the invention in open and closed states 1600A and 1600B respectively wherein the BOP is established to operate between a drill string 1620 and casing 1610. Such a configuration occurring for example during drilling as evident from the drill bit 1630 disposed at the end of the drill string 1620. The BOP comprising an annular ring 1650 designed to fit the inner diameter of the casing 1610 having an opening 1670 through which the drill string 1620 passes. The BOP also comprising a plug 1640 comprising a bore, not identified for clarity, for the drill string. The plug 1640 and annular ring 1650 being coupled via springs 1660 in a similar manner to the BOP presented supra in FIG. 7. Accordingly the BOP transitions from open state 1600A to closed state 1600B as the pressure increases in the casing 1610 thereby increasing the force applied to the plug 1640 and compressing the springs 1660. The BOP may be deployed on the drill string 1620 as the drilling operation progresses and automatically operated whilst the drill string 1620 is still in place.

Plug 1640 being designed for example as depicted supra in respect of FIG. 8 to allow liquid flow under normal operation from the region around the drill bit up past the plug when not in closed state 1600B and upwards along riser 1620 towards drilling rig as well as providing the solid section to block the flow and the predetermined surface area to generate the force under operation to compress the spring and restrict/close the BOP. It would be evident that the BOP can be placed onto the drill string during operations and may accordingly be placed at a predetermined distance from the drill bit 1830 as drilling continues rather than at the top of the well either on land or at the bottom of the sea. Upon reduction of pressure in the casing 1710 the BOP will re-open allowing liquid to reflow.

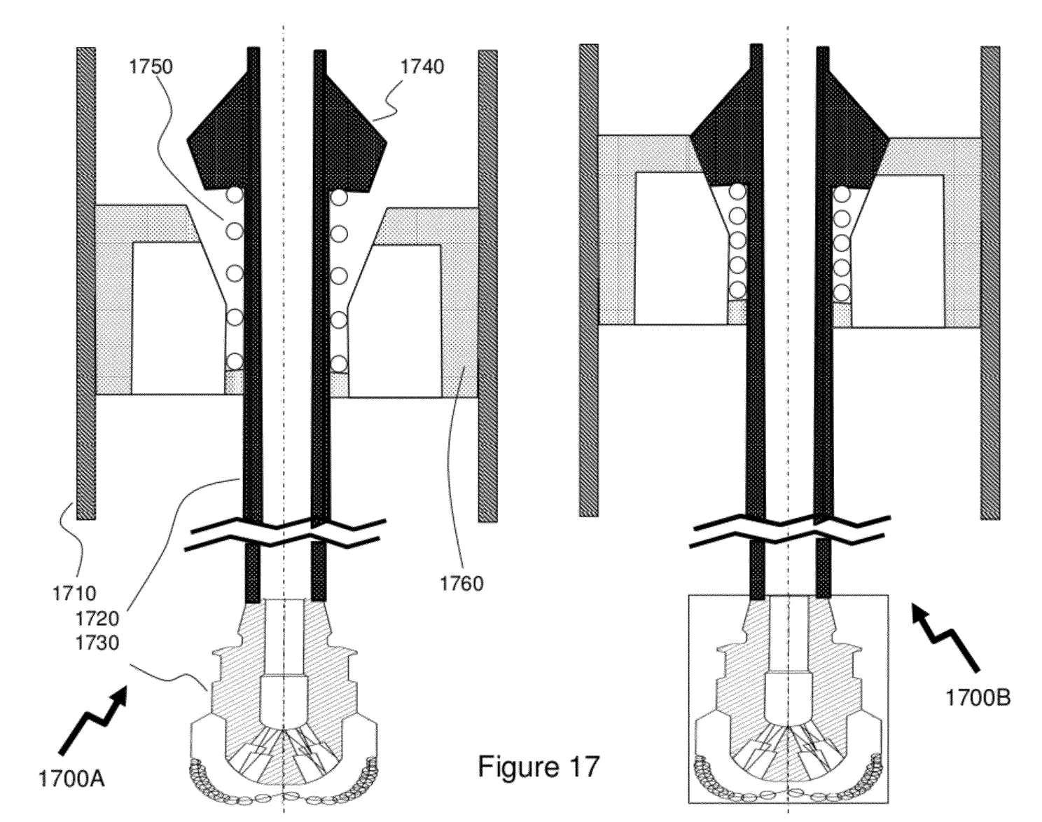

Referring to FIG. 17 there is depicted a BOP according to an embodiment of the invention in open and closed states 1700A and 1700B respectively wherein the BOP is established to operate between a drill string 1720 and casing 1710. Such a configuration occurring for example during drilling as evident from the drill bit 1730 disposed at the end of the drill string 1720. The drill string 1720 having an integral annular protuberance 1740. Disposed around the drill string 1720 is spring 1750 that fits between annular protuberance 1740 and plug 1760. Accordingly in open state 1700A liquid from below the BOP flows through the channels within the plug 1760.

As pressure increases the plug 1760 applies increasing force to the spring 1750 compressing it and thereby initially limiting, and then closing the BOP as the plug 1760 closes the opening between the annular protuberance 1740 and casing 1710. Plug 1760 being designed for example as depicted supra in respect of FIG. 8 to provide the solid plug, openings for liquid passage but modified to provide the central opening allowing the drill string 1720 to pass through. It would be evident that the BOP can be placed onto the drill string during operations and may accordingly be placed at a predetermined distance from the drill bit 1730 as drilling continues rather than at the top of the well either on land or at the bottom of the sea. Upon reduction of pressure in the casing 1710 the BOP will re-open allowing liquid to reflow.

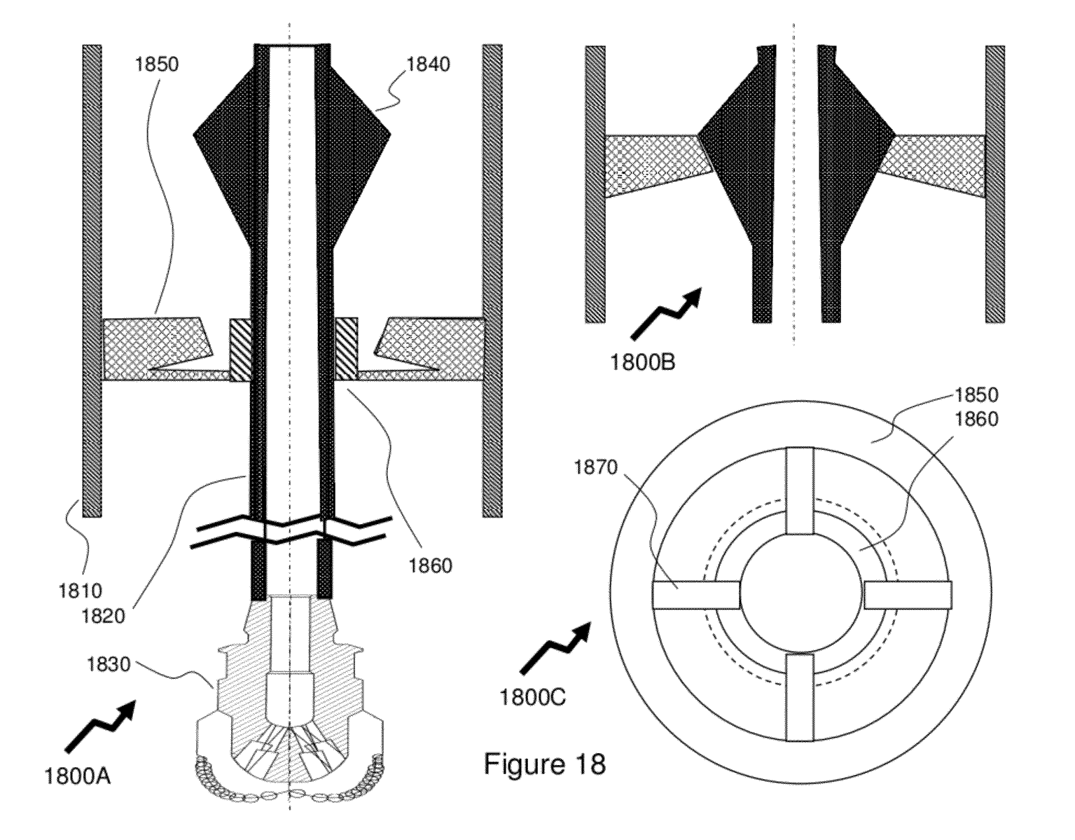

Referring to FIG. 18 there is depicted a BOP according to an embodiment of the invention in open and closed states 1800A and 1800B. As shown in open state 1800 a riser 1810 has disposed within a drill string 1820 terminating in a drill bit 1830. The drill string 1820 has an annular protuberance 1840 disposed at one region and a plug assembly comprising plug 1850 and sacrificial mounting 1860 below at a predetermined separation. Accordingly in operation the liquid flows through openings in the plug 1850. As pressure increases to and exceeds the predetermined trigger pressure of the BOP the sacrificial mounting 1860 releases the plug 1850 such that it is pushed up the casing 1810 and engages the annular protuberance 1840, as shown in closed state 1800B thereby closing the BOP and stopping liquid flow up the riser 1810.

Plug assembly being designed for example as depicted supra in respect of FIG. 8, and as shown on 1800C, wherein a plurality of radial members 1870 connect the plug 1850 to the sacrificial mounting 1860. It would be evident that the BOP can be placed onto the drill string during operations and may accordingly be placed at a predetermined distance from the drill bit 1830 as drilling continues rather than at the top of the well either on land or at the bottom of the sea. Upon reduction of pressure in the casing 1810 the BOP will re-open allowing liquid to reflow.

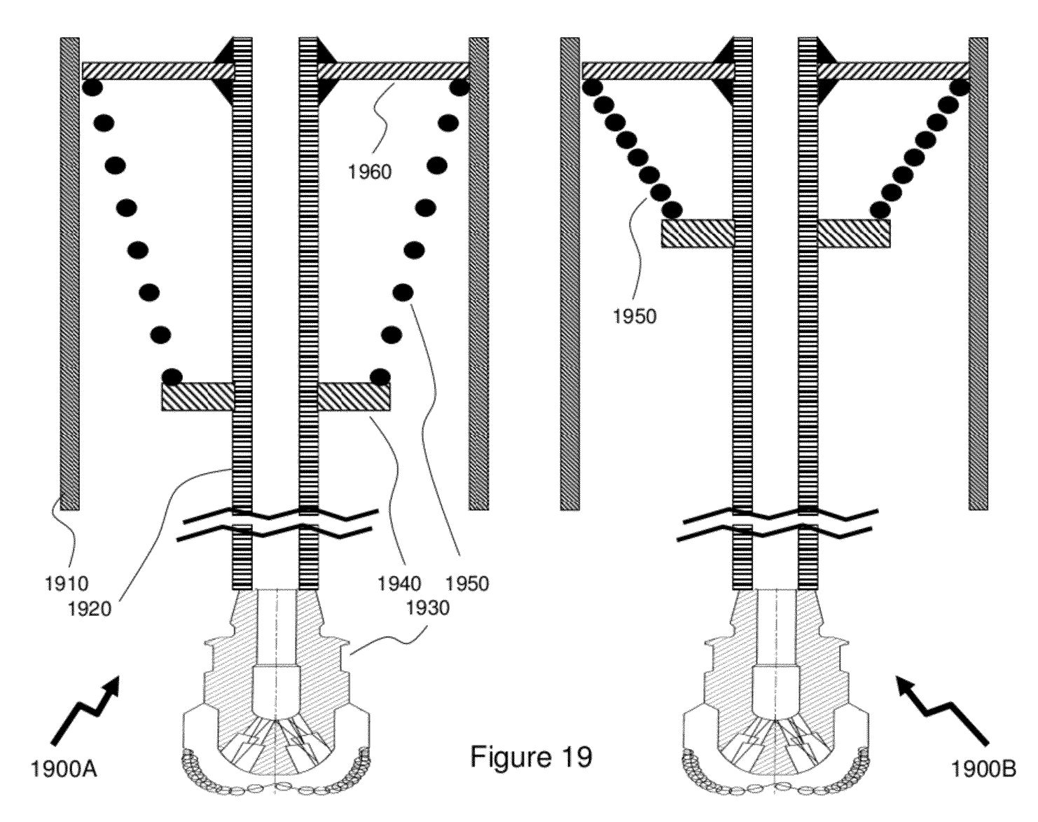

Now referring to FIG. 19 there is depicted a BOP according to an embodiment of the invention depicted in open and closed states 1900A and 1900B respectively. As shown in open state 1900A a drill string 1920 terminating at its lower end with drill bit 1930 is disposed within casing 1910. Mounted to the drill string 1920 is BOP frame 1960 to which spring 1950 is mounted and extends downwards towards drill bit 1930. At the other end of spring 1950 there is disposed pressure plate 1940. As pressure within the casing increases the force applied to the pressure plate 1940 increases thereby compressing the spring1950 as the spring 1950 is rigidly held by the BOP frame 1960. Accordingly, the pressure plate 1940 moves upwards along the drill string 1920 until the pressure reaches the designed closing pressure for the BOP at which point the spring 1950 is fully compressed, as shown in closed state 1900B, thereby closing the BOP.

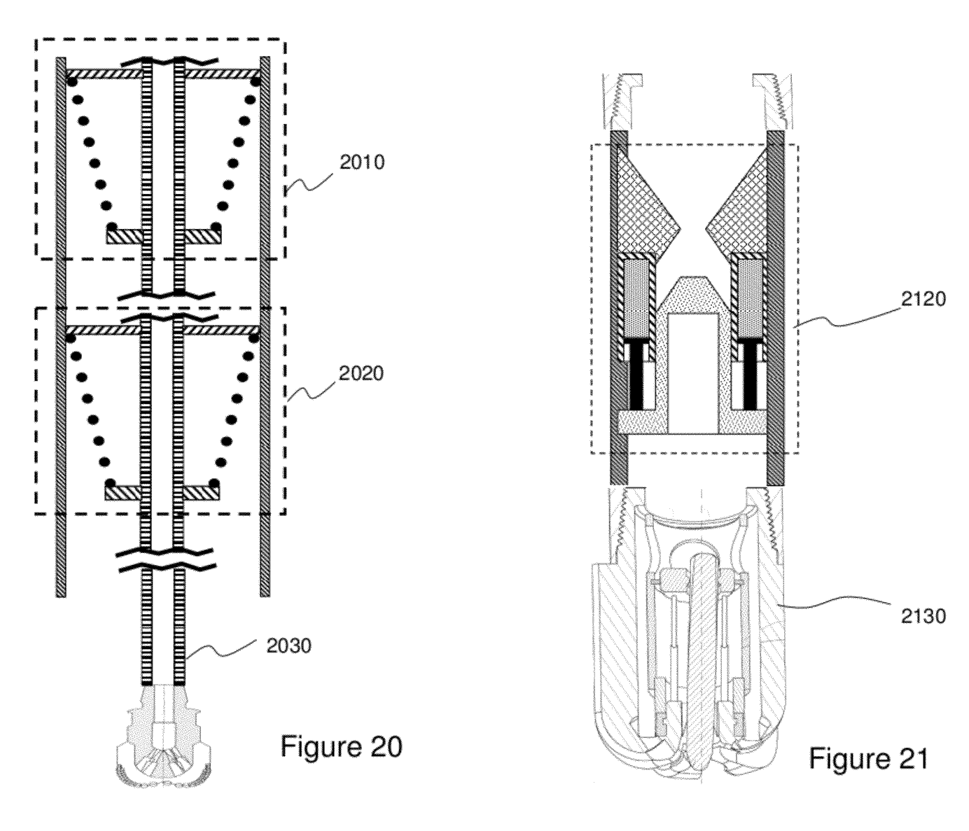

Referring to FIG. 20 there are shown first and second BOP units 2010 and 2020 deployed upon the same drill string 2030. The first and second BOP units 2010 and 2020 may optionally be designed to operate at the same pressure, such that there is dual redundancy or alternatively they may be designed to operate at different pressures. It would be evident to one skilled in the art that such automatic reversible BOPs may be deployed within the drill string.

Now referring to FIG. 21 there is shown a drill string 2100 comprising a reversible hydraulic BOP 2120 unit deployed on a drill bit 2130 at the bottom of the drill piping, not shown for clarity. Reversible hydraulic BOP 2120 being of a design such as shown above in FIG. 9. Accordingly the reversible hydraulic BOP 2120 allows “kicks” back up the drill string to be stopped at the drill bit 2130 rather than at a conventional BOP installed at the surface of the drilling either on land or at the seabed.

It would be apparent to one skilled in the art that multiple BOP unit may be deployed both within the drill string and between the drill string and the casing and that the designs of the multiple BOPs may be the same or different from amongst the embodiments of the invention presented in respect of FIGS. 7 through 21 Likewise where pressure relief structures are employed in conjunction with an inline BOP the operating mechanisms of the inline BOP and relief valve may the same or different. Similarly multiple BOP devices and relief valves may be designed to operate at the same pressure or different pressures. Whilst deployment of the BOPs and relief valves has been primarily described in respect of deployments within portions of the oil/gas well underground they may be equally applied to other portions of the overall oil/gas well. Likewise embodiments of the invention presented without a drill string in place may be modified to support a drill string and those shown with a drill string may be modified to be operate without a drill string. Such variants being within the scope of the invention.

It would also be apparent that the pressure valves of embodiments of the invention described in respect of FIGS. 7 through 21 may be employed in a wide variety of other gas/liquid piping systems where closure of the system at critical pressures is required. Beneficially, embodiments of the invention limit flow prior to closure in a gradual manner.

It would be evident that the BOP devices presented supra may be disposed within standard lengths of piping or that they may be manufactured as discrete elements that are assembled onto the drill string or production tubing and hence may be shorter sections of piping. In this manner multiple BOPs may be added to drilling or production tubing with the same or different closing pressures according to the activities being performed and the requirements for back-up BOPs and redundancy.

Whilst within the embodiments of the invention relating to relief valves the control mechanisms have been considered as hydraulic rams it would be evident that alternative structures may be employed including but not limited to linear translation stages for example. Optionally the plug may be made from a magnetic material such that the movement of the plug relative to the annular ring and the opening may be monitored by a magnetic sensor disposed outside the pipe.

The above-described embodiments of the present invention are intended to be examples only. Alterations, modifications and variations may be effected to the particular embodiments by those of skill in the art without departing from the scope of the invention, which is defined solely by the claims appended hereto.

What is claimed is:

1. A method comprising:
providing a ring assembly attached to the inner surface of a pipe comprising an opening of predetermined geometry;
providing a compliant structure, a first distal end abutting the ring assembly in a manner not restricting the opening and having a predetermined length versus force characteristic;
providing a plug assembly abutting a second distal end of the compliant structure and comprising a plug forming a predetermined portion of the plug assembly having an external geometry over a predetermined portion of the plug to fit in abutting relationship to the opening.

2. The method according to claim 1 wherein,
the compliant structure is at least one of a spring, a hydraulic ram, and a ram containing a compressible material.

3. The method according to claim 1 wherein,
the length versus force characteristic may be adjusted via a control system connected to the compliant structure.

4. The method according to claim 1 further comprising;
a first predetermined portion of a latching mechanism disposed at least one of within the pipe and forming part of the pipe;
a second predetermined portion of the latching mechanism forming part of the plug assembly;
wherein when the plug is abutting the opening the latching mechanism engages thereby preventing subsequent movement of the plug relative to the opening.

5. The method according to claim 1 further comprising;
a relief valve disposed on the outer surface of the pipe coupled to an opening on the pipe, the opening being on the side of the pipe wherein increased pressure results in the plug moving toward the opening.

6. The method according to claim 5 wherein,
the relief valve at least one of automatically opens at a predetermined pressure threshold and is controllably opened.

7. The method according to claim 6 wherein,
when the relief valve automatically opens the predetermined pressure threshold is established relative to the pressure causing the plug to engage in the opening and close the pipe.

8. A device comprising:
a ring assembly attached to the inner surface of a pipe comprising an opening of predetermined geometry;
a compliant structure, a first distal end abutting the ring assembly in a manner not restricting the opening and having a predetermined length versus force characteristic;
a plug assembly abutting a second distal end of the compliant structure and comprising a plug forming a predetermined portion of the plug assembly having an external geometry over a predetermined portion of the plug to fit in abutting relationship to the opening.

9. The method according to claim 8 wherein,
the compliant structure is at least one of a spring, a hydraulic ram, and a ram containing a compressible material.

10. The method according to claim 8 wherein,
the length versus force characteristic may be adjusted via a control system connected to the compliant structure.

11. The method according to claim 8 further comprising;
a first predetermined portion of a latching mechanism disposed at least one of within the pipe and forming part of the pipe;
a second predetermined portion of the latching mechanism forming part of the plug assembly;
wherein when the plug is abutting the opening the latching mechanism engages thereby preventing subsequent movement of the plug relative to the opening.

12. The method according to claim 8 further comprising;
a relief valve disposed on the outer surface of the pipe coupled to an opening on the pipe, the opening being on the side of the pipe wherein increased pressure results in the plug moving toward the opening.

13. The method according to claim 12 wherein,
the relief valve at least one of automatically opens at a predetermined pressure threshold and is controllably opened.

14. The method according to claim 13 wherein,
when the relief valve automatically opens the predetermined pressure threshold is established relative to the pressure causing the plug to engage in the opening and close the pipe.
